(19) United States
(12) Patent Application Publication
(10) Pub. No.: US 2022/0262248 A1
(43) Pub. Date: Aug. 18, 2022

(54) VEHICLE NAVIGATION METHOD AND TERMINAL

(71) Applicant: HUAWEI TECHNOLOGIES CO., LTD., Shenzhen (CN)

(72) Inventors: Shanfu LI, Shenzhen (CN); Huimin ZHANG, Shenzhen (CN)

(73) Assignee: HUAWEI TECHNOLOGIES CO., LTD., Shenzhen (CN)

(21) Appl. No.: 17/736,659

(22) Filed: May 4, 2022

Related U.S. Application Data
(63) Continuation of application No. PCT/CN2020/100570, filed on Jul. 7, 2020.

(30) Foreign Application Priority Data
Nov. 5, 2019 (CN) 201911070985.4

(51) Int. Cl. G08G 1/0968; G01C 21/36

(52) U.S. Cl. CPC G08G 1/096805; G01C 21/3658; G08G 1/096838

(57) ABSTRACT

A vehicle navigation method and a terminal (101, 800, 900) are provided, applied to the Internet of Vehicles, for example, V2X, LTE-V, V2V, and V2I, and used to provide lane-level vehicle navigation for an intelligent vehicle. When a first vehicle travels to the to-be-traveled road, the terminal (101, 800, 900) performs vehicle navigation for the first vehicle based on the target lane selection information. Lane-level vehicle navigation is performed for the first vehicle based on the target lane selection information, so that a driving behavior of the first vehicle adapts to a driving behavior of the second vehicle on a same road, and complies with the driving preference information, to improve traveling experience of a passenger in the first vehicle.

### CROSS-REFERENCE TO RELATED APPLICATIONS

This application is a continuation of International Application No. PCT/CN2020/100570, filed on Jul. 7, 2020, which claims priority to Chinese Patent Application No. 201911070985.4, filed on Nov. 5, 2019. The disclosures of the aforementioned applications are hereby incorporated by reference in their entireties.

### TECHNICAL FIELD

This application relates to the Internet of vehicles field, and in particular, to a vehicle navigation method and a terminal.

### BACKGROUND

Currently, with the continuous development of communication technologies, a navigation system may be loaded onto a device such as a mobile terminal, a car navigation device, or a self-driving car, to implement vehicle navigation. With the improvement of a technology such as a high-precision positioning technology and a high-precision map, it is possible to provide lane-level navigation for a vehicle.

In a conventional technology, in a traveling process of a vehicle, a navigation system of the vehicle can provide driving plans on a plurality of routes, and may display road information of each route, for example, a quantity of lanes, a road congestion status, predicted duration for passing through a congested road, and a road fork status. Then, navigation information is further provided based on a driving preference setting of a driving user, to assist a driver in driving the vehicle or provide a decision basis for self-driving.

However, driving behavior habits of different vehicle drivers may be different. As a result, even if exactly same navigation information is used on a same road, different vehicle drivers select different lanes. Consequently, actual traveling experience of a passenger in the vehicle on the road cannot reach an expectation of the navigation information, and user experience is affected.

### SUMMARY

Embodiments of this application provide a vehicle navigation method and a terminal, to provide lane-level navigation for a vehicle.

A first aspect of the embodiments of this application provides a vehicle navigation method. The method is applied to a terminal. A first vehicle may access the Internet of vehicles by using the terminal, for example, a scenario such as vehicle-to-everything (V2X, vehicles to X) information exchange, vehicle to vehicle (V2V, vehicles to vehicles) information exchange, and vehicle to infrastructure (V2I, vehicles to infrastructure) information exchange. The terminal may provide vehicle navigation for the first vehicle. In a process of implementing vehicle navigation for the first vehicle, the terminal obtains an identifier of a to-be-traveled road of the first vehicle. Then, the terminal obtains driving information of a second vehicle based on the identifier of the to-be-traveled road. The second vehicle may include a plurality of vehicles traveling on the to-be-traveled road, and the second vehicle may also be a vehicle accessing the Internet of vehicles. The driving information of the second vehicle includes lane selection information of the second vehicle on the to-be-traveled road. The lane selection information of the second vehicle on the to-be-traveled road includes a set of lane selection information of a plurality of second vehicles traveling on the to-be-traveled road, or may include a set of lane selection information for a plurality of times of traveling of a second vehicle traveling on the to-be-traveled road. Next, the terminal obtains driving preference information of the first vehicle. The driving preference information may include a driving preference that is preset for the first vehicle on the to-be-traveled road. The terminal determines, from the driving information of the second vehicle as target lane selection information, lane selection information that matches the driving preference information. In other words, the terminal determines, from a set of a plurality of pieces of lane selection information of the second vehicle traveling on the to-be-traveled road, the target lane selection information that complies with the driving preference information. When the first vehicle travels to the to-be-traveled road, the terminal performs vehicle navigation for the first vehicle based on the target lane selection information. Lane-level vehicle navigation is performed for the first vehicle based on the target lane selection information, so that a driving behavior of the first vehicle adapts to a driving behavior of the second vehicle on a same road, and complies with the driving preference information, to improve traveling experience of a passenger in the first vehicle.

It should be noted that the driving information of the second vehicle may be the following information in a process in which the second vehicle travels on the to-be-traveled road: information recorded by an event data recorder, information recorded by a laser radar, GPS positioning information, or other driving information that may be used to determine the lane selection information of the second vehicle on the to-be-traveled road.

In a possible implementation of the first aspect, a process in which the terminal obtains the second driving information of the second vehicle based on the identifier of the to-be-traveled road may be obtained through exchange with a server. The process may specifically include: The terminal sends a first data request message to the server, so that the server determines a plurality of pieces of driving information based on the first data request message. For example, the server may obtain a plurality of pieces of driving information in a city positioned by the terminal within preset duration, or simulate and predict a plurality of pieces of driving information at a destination based on a historical driving requirement of the terminal, or another manner may be used. This is not limited herein. Subsequently, the terminal receives the plurality of pieces of driving information sent by the server, and determines the driving information of the second vehicle from the plurality of pieces of driving information based on the identifier of the to-be-traveled road. In addition, the server herein may be a server in the Internet of vehicles, such as a distributed storage device, a distributed computing array, a control management platform, or another infrastructure in an Internet of vehicles system. This is not limited herein.

In this possible implementation, the terminal may specifically obtain the second driving information of the second vehicle by receiving data sent by the server and then by using a calculation process of the terminal, to provide a specific implementation of obtaining the driving information of the second vehicle. This increases implementability of the solution.

In a possible implementation of the first aspect, a process in which the terminal obtains the second driving information of the second vehicle based on the identifier of the to-be-traveled road may be obtained through exchange with the second vehicle. The process may specifically include: The terminal sends a second data request message to the second vehicle, so that the second vehicle determines a plurality of pieces of driving information of the second vehicle based on the first data request message. For example, the second vehicle may determine a plurality of pieces of driving information within a previous year/month/week/the like or corresponding to other duration. Subsequently, the terminal receives the plurality of pieces of driving information of the second vehicle that are sent by the second vehicle, and determines the driving information of the second vehicle from the plurality of pieces of driving information of the second vehicle based on the identifier of the to-be-traveled road.

In this possible implementation, the terminal may specifically obtain the second driving information of the second vehicle by receiving data sent by the second vehicle and then by using a calculation process of the terminal, to provide a specific implementation of obtaining the driving information of the second vehicle. This increases implementability of the solution.

In a possible implementation of the first aspect, a process in which the terminal obtains the second driving information of the second vehicle based on the identifier of the to-be-traveled road may be obtained through exchange with a server. The process may specifically include: The terminal sends a third data request message to the server, where the third data request message includes the identifier of the to-be-traveled road, so that the server determines, based on the third data request message, the driving information of the second vehicle traveling on the to-be-traveled road. Subsequently, the terminal receives the driving information that is of the second vehicle and that is sent by the server. In addition, the server herein may be a server in the Internet of vehicles, such as a distributed storage device, a distributed computing array, a control management platform, or another infrastructure in an Internet of vehicles system. This is not limited herein.

In this possible implementation, the second driving information of the second vehicle may be specifically obtained by receiving data sent by the server, and an operation process in a determining step may be implemented by the server with a strong operation capability, to effectively reduce a delay of obtaining navigation information.

In a possible implementation of the first aspect, a process in which the terminal obtains the second driving information of the second vehicle based on the identifier of the to-be-traveled road may be obtained through direct exchange with the second vehicle. The process specifically includes: The terminal sends a fourth data request message to the second vehicle, where the fourth data request message includes the identifier of the to-be-traveled road, so that the second vehicle determines the driving information of the second vehicle on the to-be-traveled road based on the identifier of the to-be-traveled road. Subsequently, the terminal receives the driving information that is of the second vehicle and that is sent by the second vehicle.

In this possible implementation, the driving information of the second vehicle may be specifically obtained through direct exchange with the second vehicle, and an operation process in a determining step may be directly implemented by the second vehicle. Therefore, a computing capability of the server may be saved, and when an alternative solution is provided, the alternative solution may be applicable to a V2V scenario, namely, interaction between vehicles, in the Internet of vehicles.

In a possible implementation of the first aspect, a process in which the terminal obtains the identifier of the to-be-traveled road of the first vehicle may specifically include: The terminal obtains initial navigation information of the first vehicle, namely, initial navigation information that is preset by a user for the first vehicle, where the initial navigation information includes an identifier of a start location. Subsequently, the terminal determines the identifier of the to-be-traveled road based on the identifier of the start location.

In this possible implementation, the terminal may obtain an identifier of an end location based on the identifier of the start location, to determine the identifier of the to-be-traveled road. In addition, the terminal may further preset a distance such as 20 km/50 km/100 km, and provide, for the user to perform selection again, all road information within a radius of the distance by using the start location. The terminal may determine the identifier of the to-be-traveled road in plurality of manners. This is not limited herein.

In a possible implementation of the first aspect, the initial navigation information further includes a to-be-traveled time period, namely, a to-be-traveled time period that is preset by the user for the first vehicle on the to-be-traveled road. In this case, the driving information of the second vehicle further includes a historical driving time period corresponding to the lane selection information of the second vehicle on the to-be-traveled road. In the method, the terminal may first determine, from the lane selection information of the second vehicle on the to-be-traveled road, the target lane selection information that matches the to-be-traveled time period and the driving preference information.

In this possible implementation, the driving information of the second vehicle further includes the historical driving time period corresponding to the lane selection information of the second vehicle on the to-be-traveled road, that is, includes a historical driving time period corresponding to each piece of lane selection information of the second vehicle on the to-be-traveled road. Therefore, the terminal may first obtain, through matching from the lane selection information of the second vehicle on the to-be-traveled road, the target lane selection information that matches the to-be-traveled time period and the driving preference information. A parameter such as a time period is introduced to screen the lane selection information, so that the obtained target lane selection information more complies with a navigation expectation of the initial navigation information of the first vehicle.

In a possible implementation of the first aspect, the driving preference information may include a duration preference, namely, driving duration that is preset for the first vehicle on the to-be-traveled road. In this case, the driving information of the second vehicle further includes lane driving duration corresponding to each piece of lane selection information in the lane selection information of the second vehicle on the to-be-traveled road. Therefore, that the terminal determines, from the driving information of the second vehicle as target lane selection information, lane selection information that matches the driving preference information may specifically include: The terminal determines, from the driving information of the second vehicle as the target lane selection information, lane selection information corresponding to lane driving duration that matches the duration preference.

In this possible implementation, the driving duration on the to-be-traveled road is used as an implementation of the driving preference information, so that the obtained target lane selection information can meet a driving duration requirement preferred by the first vehicle.

In a possible implementation of the first aspect, the driving preference information may include a difficulty preference, namely, a driving difficulty that is preset for the first vehicle on the to-be-traveled road. In this case, the driving information of the second vehicle further includes lane road-condition complexity corresponding to each piece of lane selection information in the lane selection information of the second vehicle on the to-be-traveled road. A level of the lane road-condition complexity is positively correlated with a magnitude of the difficulty preference. Therefore, that the terminal determines, from the driving information of the second vehicle as target lane selection information, lane selection information that matches the driving preference information may specifically include: The terminal determines, from the driving information of the second vehicle as the target lane selection information, lane selection information corresponding to lane road-condition complexity that matches the difficulty preference.

In this possible implementation, the driving difficulty preference on the to-be-traveled road is used as an implementation of the driving preference information, so that the obtained target lane selection information can meet a driving difficulty requirement preferred by the first vehicle.

In a possible implementation of the first aspect, the driving preference information may include a safety preference, namely, a safety preference that is preset for the first vehicle on the to-be-traveled road. In this case, the driving information of the second vehicle further includes a quantity of abnormal driving behaviors that corresponds to each piece of lane selection information in the lane selection information of the second vehicle on the to-be-traveled road. The quantity of abnormal driving behaviors is negatively correlated with a safety level. Therefore, that the terminal determines, as target lane selection information, lane selection information that matches the driving preference information may specifically include: The terminal determines, from the driving information of the second vehicle as the target lane selection information, lane selection information corresponding to a quantity of abnormal behaviors that matches the safety preference.

In this possible implementation, the driving safety preference on the to-be-traveled road is used as an implementation of the driving preference information, so that the obtained target lane selection information can meet a driving safety requirement preferred by the first vehicle.

In a possible implementation of the first aspect, if the target lane selection information further includes lane change information, namely, lane selection information indicating that a lane needs to be changed for traveling on the to-be-traveled road, a process in which the terminal performs vehicle navigation for the first vehicle based on the target lane selection information may specifically include: The terminal sends a third data request to the server, where the third data request is used to request a lane change decision of the first vehicle in the lane change information. The terminal receives a first lane change instruction sent by the server, where the first lane change instruction is determined by the server based on the fifth data request message. The terminal performs vehicle navigation for the first vehicle based on the first lane change instruction.

In this possible implementation, in a process of performing vehicle navigation based on the target lane selection information, if the terminal determines that the target lane selection information includes the lane change information, the terminal sends the third data request to the server, so that the server determines the first lane change instruction of the first vehicle based on globally monitored vehicle information. Then, the terminal performs vehicle navigation, that is, executes a lane change process, for the first vehicle based on the first lane change instruction.

In a possible implementation of the first aspect, if the target lane selection information further includes lane change information, the terminal may further implement, through real-time obtaining, navigation related to the lane change information, and a process in which the terminal performs vehicle navigation for the first vehicle based on the target lane selection information may specifically include: The terminal obtains, based on the lane change information, lane selection information associated with the lane change information. The terminal determines a second lane change instruction based on the lane selection information associated with the lane change information. The terminal performs vehicle navigation for the first vehicle based on the second lane change instruction.

In this possible implementation, in a process of performing vehicle navigation based on the target lane selection information, if the terminal determines that the target lane selection information includes the lane change information, the terminal may obtain, in real time, lane selection information that is of a vehicle related to the lane change information and that is associated with the lane change information. Then, the terminal determines the second lane change instruction by performing an operation by the terminal, and further performs vehicle navigation, that is, executes a lane change process, for the first vehicle based on the second lane change instruction.

In a possible implementation of the first aspect, that the terminal obtains, based on the lane change information, lane selection information associated with the lane change information may specifically include: The terminal sends a fourth data request message to the server, where the fourth data request message includes the lane change information. The terminal receives the lane selection information that is sent by the server and that is associated with the lane change information.

In this possible implementation, a process in which the terminal obtains the lane selection information associated with the lane change information may be obtained through exchange with the server, that is, the server determines the lane selection information associated with the lane change information.

In a possible implementation of the first aspect, that the terminal obtains, based on the lane change information, lane selection information associated with the lane change information may specifically further include: The terminal determines, based on the lane change information, a third vehicle associated with the lane change information. The terminal sends a fifth data request message to the third vehicle, where the fifth data request message includes the lane change information. The terminal receives the lane selection information that is sent by the third vehicle and that is associated with the lane change information.

In this possible implementation, a process in which the terminal obtains the lane selection information associated with the lane change information may be obtained through V2V in the Internet of vehicles, that is, the terminal determines the third vehicle associated with the first lane change information, to determine, by directly exchanging data with the third vehicle, the lane selection information associated with the lane change information.

A second aspect of the embodiments of this application provides a terminal. The terminal has a function of implementing the method according to any one of the first aspect or the possible implementations of the first aspect. The functions may be implemented by using hardware, or may be implemented by using hardware executing corresponding software. The hardware or the software includes one or more modules corresponding to the foregoing function, for example, an obtaining unit, a determining unit, and a navigation unit.

A third aspect of the embodiments of this application provides a terminal. The terminal includes a processor and a memory. The memory is configured to store program instructions. The processor is configured to execute the program instructions to implement the method according to any one of the first aspect or the possible implementations of the first aspect.

A fourth aspect of the embodiments of this application provides a computer-readable storage medium that stores one or more computer-executable instructions. When the computer-executable instruction is executed by a processor, the processor performs the method according to any one of the first aspect or the possible implementations of the first aspect.

A fifth aspect of the embodiments of this application provides a computer program product (or referred to as a computer program) that stores one or more computer-executable instructions. When the computer-executable instruction is executed by a processor, the processor performs the method according to any one of the first aspect or the possible implementations of the first aspect.

A sixth aspect of the embodiments of this application provides a chip system. The chip system includes a processor, configured to support a controller in implementing a function in any one of the first aspect or the possible implementations of the first aspect. In a possible design, the chip system may further include a memory. The memory is configured to store program instructions and data that are necessary for the controller. The chip system may include a chip, or may include a chip and another discrete component.

For technical effects brought by any one of the second aspect to the sixth aspect or the possible implementations of the second aspect to the sixth aspect, refer to technical effects brought by the first aspect or the different possible implementations of the first aspect. Details are not described herein again.

In the vehicle navigation method provided in this application, the terminal determines, from the set of the plurality of pieces of lane selection information of the second vehicle traveling on the to-be-traveled road, the target lane selection information that complies with the driving preference information. When the first vehicle travels to the to-be-traveled road, the terminal performs vehicle navigation for the first vehicle based on the target lane selection information. Lane-level vehicle navigation is performed for the first vehicle based on the target lane selection information, so that a driving behavior of the first vehicle adapts to a driving behavior of the second vehicle on a same road, and complies with the driving preference information, to improve traveling experience of a passenger in the first vehicle.

### BRIEF DESCRIPTION OF DRAWINGS

FIG. 1 is a framework diagram of a system according to an embodiment of this application;

FIG. 2 is a schematic diagram of an embodiment of a vehicle navigation method according to an embodiment of this application;

FIG. 3 is another schematic diagram of an embodiment of a vehicle navigation method according to an embodiment of this application;

FIG. 4 is another schematic diagram of an embodiment of a vehicle navigation method according to an embodiment of this application;

FIG. 5 is another schematic diagram of an embodiment of a vehicle navigation method according to an embodiment of this application;

FIG. 6 is another schematic diagram of an embodiment of a vehicle navigation method according to an embodiment of this application;

FIG. 7 is another schematic diagram of an embodiment of a vehicle navigation method according to an embodiment of this application;

FIG. 8 is a schematic diagram of a terminal according to an embodiment of this application; and

FIG. 9 is another schematic diagram of a terminal according to an embodiment of this application.

### DESCRIPTION OF EMBODIMENTS

Embodiments of this application provide a vehicle navigation method and a terminal, to provide lane-level navigation for a vehicle.

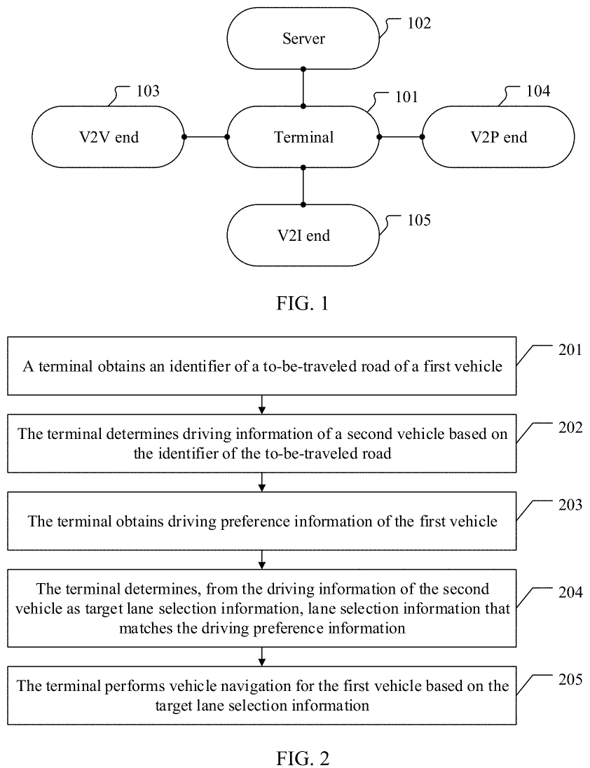

FIG. 1 is a framework diagram of a system implemented in an embodiment of this application. The system may include a terminal 101, a server 102, a V2V end 103, a V2P end 104, and a V2I end 105.

The server 102 may include a distributed storage device, a distributed computing array, a control management platform, and the like, and is configured to: store and calculate a cloud dynamic map, and check a vehicle for management control and monitoring. For example, the server 102 may further include a vehicle control subsystem and a traffic information subsystem. The vehicle control subsystem is responsible for safely and efficiently controlling traveling of a vehicle, and the traffic information subsystem is responsible for accurately collecting, processing, and exchanging information about a traffic participant in a timely manner. The server 102 may exchange information with the vehicle, or each subsystem in the server 102 includes an information management device of the subsystem. Each information management device implements a function of a subsystem to which the information management device belongs, and exchanges information with the vehicle. In actual application, a specific implementation is not limited in this application.

The V2V end 103 includes all other vehicle-end communication systems and devices that exchange information with the system. In some embodiments, an ad hoc network may be established between vehicles, and the vehicles directly communicate with each other without using a unified management center. In some embodiments, the vehicle may perform communication only by using a management center. Similar to a manner in which a mobile phone accessing an operator, the vehicle is a large mobile terminal in the future. The vehicle accesses an operator network such as 5G and 6G by using the operator, so that the vehicles can communicate with each other. In addition, the V2P end 104 includes all handheld wireless communication devices of road pedestrians that exchange information with the system. The V2I end 105 includes all roadside communication infrastructures that exchange information with the system.

In the vehicle navigation method provided in the embodiments of this application, the method may be applied to any terminal that provides navigation for a vehicle. For example, the terminal may be a vehicle, or may be an in-vehicle terminal in a vehicle, or may be a terminal used to perform remote navigation for a vehicle, or another terminal. This is not limited herein. When the terminal is a terminal used to perform remote navigation for a vehicle, the terminal may also perform vehicle navigation for a plurality of first vehicles. For example, in the self-driving field, when a vehicle owner has a plurality of vehicles, and needs to assign each vehicle to arrive at a specified location, the terminal may also be used to perform vehicle navigation for the plurality of first vehicles. In addition, the first vehicle may access the Internet of vehicles by using the terminal, for example, a scenario such as V2X, V2V, and V2I. The terminal may provide vehicle navigation for the first vehicle. The first vehicle may be an intelligent vehicle, for example, a self-driving car or a non-self-driving car. In a process in which the terminal performs vehicle navigation for the first vehicle, a corresponding method in the embodiments of this application may be used to provide lane-level navigation for the vehicle, to improve traveling experience of a passenger in the vehicle.

Refer to FIG. 2. An embodiment of a vehicle navigation method in an embodiment of this application includes the following steps:

201. A terminal obtains an identifier of a to-be-traveled road of a first vehicle.

In this embodiment, in a process of performing vehicle navigation for the first vehicle, the terminal obtains the identifier of the to-be-traveled road of the first vehicle. The identifier of the to-be-traveled road may include an identifier of a start location and an identifier of a terminal location. Then, the terminal determines, based on the identifier of the start location and the identifier of the terminal location, a road on which the first vehicle is to travel, namely, the to-be-traveled road.

Specifically, there are a plurality of manners in which the terminal obtains the identifier of the to-be-traveled road. For example, the terminal may determine the identifier of the to-be-traveled road based on a vehicle use habit (a commuting route, a weekend trip route, or the like) of the first vehicle. Alternatively, the terminal may determine the identifier of the to-be-traveled road based on an input instruction (a navigation start location, a destination identifier, or the like) of a user. Alternatively, another manner may be used. This is not limited herein.

202. The terminal obtains driving information of a second vehicle based on the identifier of the to-be-traveled road.

In this embodiment, the terminal obtains the driving information of the second vehicle based on the identifier that is of the to-be-traveled road and that is obtained in step 201. The second vehicle includes a vehicle traveling on the to-be-traveled road, and the driving information of the second vehicle includes lane selection information of the second vehicle on the to-be-traveled road.

Specifically, the second vehicle may include a vehicle currently traveling on the to-be-traveled road, and the second vehicle may also include a vehicle that has traveled through the to-be-traveled road. This is not limited herein. In addition, the second vehicle may also access an Internet of vehicles system in which the first vehicle is located, and may perform communication by using a scenario such as V2X, V2V, or V2I in a server. In addition, there may be a plurality of vehicles traveling on the to-be-traveled road, that is, there may be a plurality of second vehicles, or there may be one second vehicle. To be specific, the lane selection information of the second vehicle on the to-be-traveled road includes a set of lane selection information of the plurality of second vehicles traveling on the to-be-traveled road, or may include a set of lane selection information for a plurality of times of traveling of a second vehicle traveling on the to-be-traveled road.

The driving information of the second vehicle herein may be the following information in a process in which the second vehicle travels on the to-be-traveled road: information recorded by an event data recorder, information recorded by a laser radar, GPS positioning information, or other driving information that may be used to determine the lane selection information of the second vehicle on the to-be-traveled road. Clearly, the lane selection information of the second vehicle on the road may be determined based on the driving information of the second vehicle.

203. The terminal obtains driving preference information of the first vehicle.

In this embodiment, the terminal obtains the driving preference information of the first vehicle, namely, a driving behavior preference of the first vehicle on the to-be-traveled road.

Specifically, similar to a process in step 201, a manner of obtaining the driving preference information of the first vehicle herein may be that the terminal determines the driving preference information of the first vehicle based on a historical driving record of the first vehicle, or may be that the terminal determines the driving preference information of the first vehicle on the to-be-traveled road based on the input instruction of the user. This is not limited herein. The driving preference information herein may be specifically a speed preference, a driving difficulty preference, a duration requirement for passing through the to-be-traveled road, a safety preference, and the like. This is not limited herein.

204. The terminal determines, from the driving information of the second vehicle as target lane selection information, lane selection information that matches the driving preference information.

In this embodiment, the terminal determines, from the driving information that is of the second vehicle and that is obtained in step 202, the target lane selection information that matches the driving preference information obtained in step 203. It may be learned from step 202 that, the lane selection information of the second vehicle on the to-be-traveled road is a set of a plurality of pieces of lane selection information of the second vehicle traveling on the to-be-traveled road. Herein, the target lane selection information that matches the driving preference information, namely, the target lane selection information that complies with the driving preference information, is determined from the set.

205. The terminal performs vehicle navigation for the first vehicle based on the target lane selection information.

In this embodiment, the terminal performs vehicle navigation for the first vehicle based on the target lane selection information determined in step 204, that is, performs lane-level navigation for traveling of the first vehicle on the to-be-traveled road.

In this embodiment, the terminal determines, from the set of the plurality of pieces of lane selection information of the second vehicle traveling on the to-be-traveled road, the target lane selection information that complies with the driving preference information. When the first vehicle travels to the to-be-traveled road, the terminal performs vehicle navigation for the first vehicle based on the target lane selection information. Lane-level vehicle navigation is performed for the first vehicle based on the target lane selection information, so that a driving behavior of the first vehicle adapts to a driving behavior of the second vehicle on a same road, and complies with the driving preference information, to improve traveling experience of a passenger in the first vehicle.

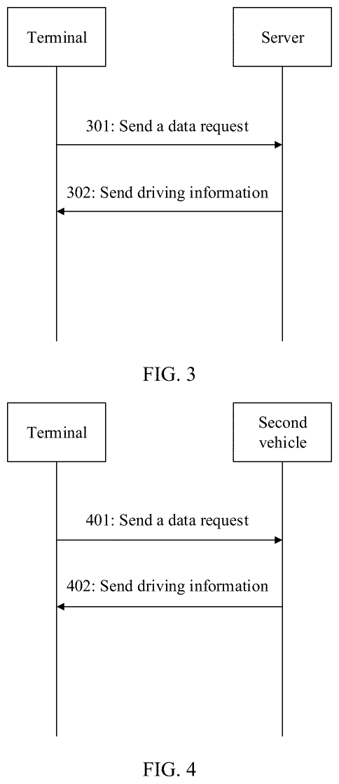

In this embodiment of this application, based on the embodiment in FIG. 2, specifically, in a process of performing step 202 that the terminal obtains driving information of a second vehicle based on the identifier of the to-be-traveled road, the terminal may execute the process in a plurality of manners. For example, the terminal may obtain the driving information of the second vehicle by exchanging data with a server, or may obtain the driving information of the second vehicle by directly exchanging data with the second vehicle. The following is separately described by using FIG. 3 and FIG. 4.

Refer to FIG. 3. Based on the embodiment in FIG. 2, in a specific implementation process of step 202, the following may be included:

301. The terminal sends a data request message to the server.

In this embodiment, the terminal may obtain the driving information of the second vehicle through exchange with the server. Specifically, the data request message sent by the terminal to the server may indicate that the terminal requests a plurality of pieces of driving information, or may indicate that the terminal requests driving information of a vehicle (the second vehicle). The terminal may send a first data request message to the server to obtain the driving information of the second vehicle from the server, where the first data request message is used to indicate to request a plurality of pieces of driving information, so that the server can obtain, based on the first data request message, a plurality of pieces of driving information in a city positioned by the terminal within preset duration, or simulate and predict a plurality of pieces of driving information at a destination based on a historical driving requirement of the terminal, or another manner may be used. This is not limited herein. Alternatively, the terminal may send a third data request message to the server, where the third data request message includes the identifier of the to-be-traveled road, so that the server determines, based on the first data request message, the driving information of the second vehicle traveling on the to-be-traveled road. Herein, the driving information that is of the second vehicle and that is determined by the server may include driving information that is of a second vehicle on the to-be-traveled road and that is obtained in real time and/or driving information of a second vehicle that has traveled through the to-be-traveled road.

In addition, as described above, the server herein may be a server in the Internet of vehicles, such as a distributed storage device, a distributed computing array, a control management platform, or another infrastructure in the Internet of vehicles system. This is not limited herein.

302. The terminal receives the driving information sent by the server.

In this embodiment, the terminal receives a response of the server to the data request message in step 301, that is, receives the driving information sent by the server. When the terminal sends the first data request message in step 301, in this step, the terminal obtains the plurality of pieces of driving information sent by the server, and then the terminal obtains the driving information of the second vehicle in step 202 based on the identifier of the to-be-traveled road. When the terminal sends the third data request message in step 301, in this step, the terminal may directly obtain the driving information that is of the second vehicle and that is sent by the server. Therefore, the second driving information of the second vehicle may be specifically obtained by receiving data sent by the server, and the driving information of the second vehicle is obtained through exchange between the terminal and the server in the Internet of vehicles.

Refer to FIG. 4. Based on the embodiment in FIG. 2, in a specific implementation process of step 202, the following may be included:

401. The terminal sends a data request message to the second vehicle.

In this embodiment, the terminal may directly exchange data with the second vehicle to obtain the driving information of the second vehicle. Herein, the terminal may send a second data request message to the second vehicle to obtain the driving information of the second vehicle from the second vehicle, where the second data request message is used to indicate to request a plurality of pieces of driving information, so that the second vehicle determines a plurality of pieces of driving information of the second vehicle based on the first data request message. For example, the second vehicle may determine a plurality of pieces of driving information within a previous year/month/week/the like or corresponding to other duration. Alternatively, the terminal may send a fourth data request message to the second vehicle, where the fourth data request message includes the identifier of the to-be-traveled road, so that the second vehicle determines the driving information of the second vehicle on the to-be-traveled road.

402. The terminal receives the driving information sent by the second vehicle.

In this embodiment, the terminal receives a response of the second vehicle to the data request message in step 401, that is, receives the driving information that is of the second vehicle and that is sent by the second vehicle. When the terminal sends the second data request message in step 401, in this step, the terminal obtains the plurality of pieces of driving information of the second vehicle that are sent by the second vehicle, and then the terminal obtains the driving information of the second vehicle in step 202 based on the identifier of the to-be-traveled road. When the terminal sends the fourth data request message in step 401, in this step, the terminal may directly obtain the driving information that is of the second vehicle and that is sent by the second vehicle. As described in step 202, herein, the second vehicle may include a vehicle currently traveling on the to-be-traveled road, and the second vehicle may also include a vehicle that has traveled through the to-be-traveled road. With a real-time communication technology implemented by using the Internet of vehicles, an operation process in a determining step may be directly implemented by the second vehicle. Therefore, a computing capability of the server may be saved, and when an alternative solution is provided, the alternative solution may be applicable to a V2V scenario, namely, interaction between vehicles, in the Internet of vehicles.

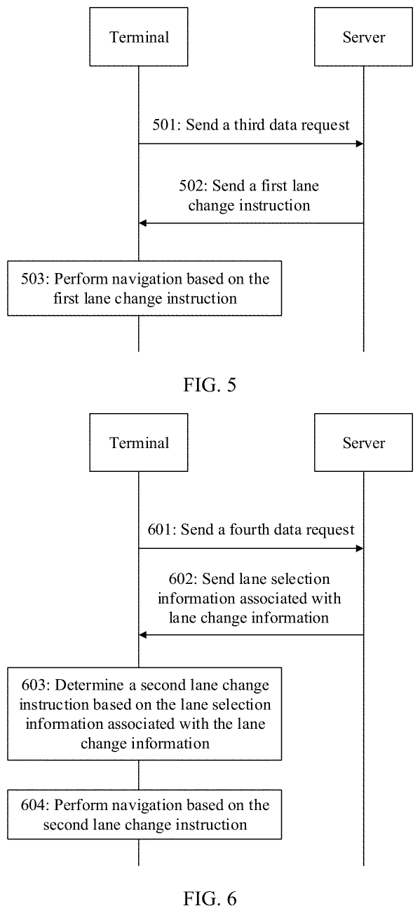

In this embodiment of this application, based on any one of the embodiments in FIG. 2 to FIG. 4, specifically, in a process of step 205 that the terminal performs vehicle navigation for the first vehicle based on the target lane selection information, when the target lane selection information includes lane change information, that is, when the target lane selection information indicates that a lane needs to be changed for traveling at an intersection or a specified location on the to-be-traveled road, the terminal may perform lane-change navigation control on the first vehicle. There are a plurality of implementations. The following is described by using specific embodiments in FIG. 5 to FIG. 7. It should be noted that a specific implementation of step 205 in the embodiment in FIG. 2 is described in the embodiments in FIG. 5 to FIG. 7. Therefore, the embodiments in FIG. 5 to FIG. 7 may be based on the process in which the terminal obtains the driving information of the second vehicle through exchange with the server in FIG. 3, or may be based on the process in which the terminal obtains the driving information of the second vehicle through exchange with the second vehicle in FIG. 4. This is not limited herein.

1. How to change a lane is determined based on a first lane change instruction sent by the server.

Refer to FIG. 5. Based on any one of the embodiments in FIG. 2 to FIG. 4, in a specific implementation process of step 205, the following may be included:

501. The terminal sends a third data request to the server.

In this embodiment, the terminal sends the third data request to the server. The third data request is used to request a lane change decision of the first vehicle in the lane change information.

Specifically, if the target lane selection information includes the lane change information, step 205 that the terminal performs vehicle navigation for the first vehicle based on the target lane selection information includes: The terminal sends the third data request to the server, where the third data request is used to request the lane change decision of the first vehicle in the lane change information. In other words, in a process of performing vehicle navigation based on the target lane selection information, if the terminal determines that the target lane selection information includes the lane change information, the terminal sends the third data request to the server, so that the server determines the first lane change instruction of the first vehicle based on globally monitored vehicle information.

502. The terminal receives the first lane change instruction sent by the server.

In this embodiment, the terminal receives the first lane change instruction sent by the server.

Specifically, after step 501 that the terminal sends a third data request to the server, the server determines a specific lane change location based on the lane change information. In this case, the server may obtain a third vehicle related to the lane change information of the first vehicle. The third vehicle includes a vehicle on a lane on which the first vehicle currently travels, a vehicle on a lane through which the first vehicle passes by changing from a current lane to a destination lane, and the like. Subsequently, the server obtains a driving status of the third vehicle, and determines a driving track of the third vehicle on the destination lane, including a start/stop location for traveling on the destination lane. Further, the server determines the lane change decision, namely, the first lane change instruction, and provides the first lane change instruction for the vehicle. For example, the first lane change instruction may instruct to prompt a lane change when a driving location of the first vehicle approaches a start location in a reference driving record, or prompt a lane change when a driving location of the first vehicle is located between start and stop locations in a reference driving record. A specific policy selection manner may be selected based on current real-time lane road-condition information.

503. The terminal performs vehicle navigation for the first vehicle based on the first lane change instruction.

In this embodiment, the terminal performs navigation for the first vehicle based on the first lane change instruction that is received in step 502 and that is sent by the server, that is, performs lane change navigation at a location corresponding to the lane change information on the to-be-traveled road.

2. How to change a lane is performed based on lane selection information associated with the lane change information.

Refer to FIG. 6. Based on any one of the embodiments in FIG. 2 to FIG. 4, in a specific implementation process of step 205, the following may be included:

601. The terminal sends a fourth data request message to the server.

In this embodiment, the terminal sends the fourth data request message to the server. The fourth data request message includes the lane change information.

Specifically, if the target lane selection information includes the lane change information, step 205 that the terminal performs vehicle navigation for the first vehicle based on the target lane selection information includes: The terminal sends the fourth data request message to the server, where the fourth data request message includes the lane change information, so that the server determines, based on the lane change information, a third vehicle related to the lane change information. When there are a plurality of third vehicles, the terminal obtains a set of lane selection information of the third vehicles, namely, the lane selection information associated with the lane change information.

602. The terminal receives the lane selection information that is sent by the server and that is associated with the lane change information.

In this embodiment, after step 601 that the terminal sends a fourth data request message to the server, the server determines, based on the fourth data request message, the lane selection information associated with the lane change information. The server may obtain the third vehicle related to the lane change information of the first vehicle. The third vehicle includes a vehicle on a lane on which the first vehicle currently travels, a vehicle on a lane through which the first vehicle passes by changing from a current lane to a destination lane, and the like. Further, the server obtains driving information of the third vehicle through exchange with the third vehicle, so that the server can determine the lane selection information associated with the lane change information.

603. The terminal determines a second lane change instruction based on the lane selection information associated with the lane change information.

In this embodiment, the terminal determines the second lane change instruction based on the lane selection information that is associated with the lane change information and that is received in step 602, that is, the terminal determines, based on lane selection information that is associated with the lane change information and that is of the third vehicle related to the lane change information, a driving intention of the third vehicle at a location indicated by the lane change information, and determines a lane change decision, namely, the second lane change instruction, based on the driving intention.

604. The terminal performs vehicle navigation for the first vehicle based on the second lane change instruction.

In this embodiment, the terminal performs navigation for the first vehicle based on the second lane change instruction determined in step 603, that is, performs lane change navigation at a location corresponding to the lane change information on the to-be-traveled road.

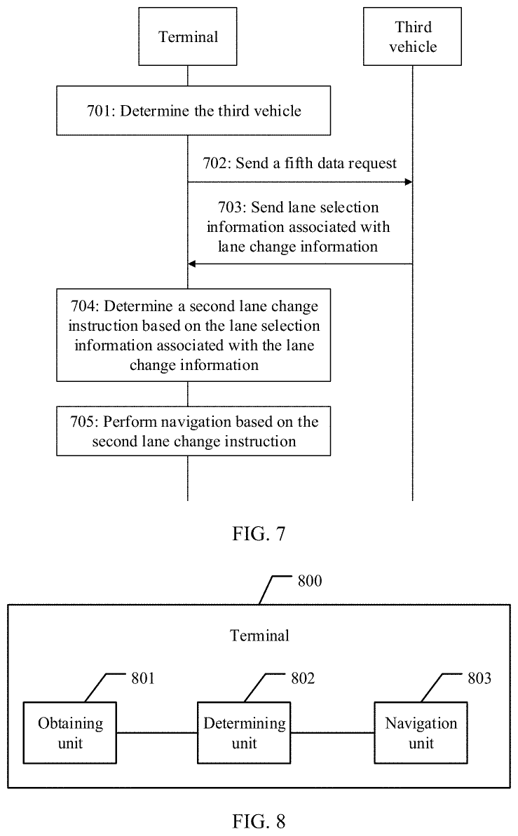

Refer to FIG. 7. Based on any one of the embodiments in FIG. 2 to FIG. 4, in a specific implementation process of step 205, the following may be included:

701. The terminal determines, based on the lane change information, a third vehicle associated with the lane change information.

In this embodiment, the terminal may determine, through V2V in the Internet of vehicles, the third vehicle associated with the lane change information, and establish a data connection to the third vehicle.

702. The terminal sends a fifth data request message to the third vehicle.

In this embodiment, the terminal sends the fifth data request message to the third vehicle. The fifth data request message includes the lane change information.

Specifically, after the terminal determines the third vehicle, the terminal may send the fifth data request message to the third vehicle. The fifth data request message includes the lane change information, that is, indicates that the terminal needs to obtain lane selection information that is of the third vehicle and that is related to the lane change information. In other words, the third vehicle needs to determine a lane selection of the third vehicle at a location corresponding to the lane change information.

703. The terminal receives the lane selection information that is sent by the third vehicle and that is associated with the lane change information.

In this embodiment, the terminal receives the lane selection information determined by the third vehicle based on the lane change information. When there are a plurality of third vehicles, the terminal receives a set of third lane selection information sent by the plurality of third vehicles, namely, the lane selection information associated with the lane change information.

704. The terminal determines a second lane change instruction based on the lane selection information associated with the lane change information.

705. The terminal performs vehicle navigation for the first vehicle based on the second lane change instruction.

For step 704 and step 705, refer to the foregoing step 603 and step 604. Details are not described herein again.

In this embodiment of this application, based on any one of the embodiments in FIG. 2 to FIG. 7, specifically, in a process of performing step 201 that a terminal obtains an identifier of a to-be-traveled road of a first vehicle, the terminal may determine the identifier of the to-be-traveled road based on the vehicle use habit (the commuting route, the weekend trip route, or the like) of the first vehicle. Alternatively, the terminal may determine the identifier of the to-be-traveled road based on the input instruction (the navigation start location, the destination identifier, or the like) of the user. Alternatively, another manner may be used. This is not limited herein. The following describes a solution in which the terminal determines the identifier of the to-be-traveled road based on the input instruction of the user.

Specifically, in the process of performing step 201 that a terminal obtains an identifier of a to-be-traveled road of a first vehicle, the terminal obtains initial navigation information of the first vehicle. The initial navigation information includes the identifier of the start location. The terminal determines the identifier of the to-be-traveled road based on the identifier of the start location. In addition, in this embodiment, the terminal may preset a distance such as 20 km/50 km/100 km based on the start location identifier, provide all road information within a radius of the distance, and then determine the to-be-traveled road based on a selection instruction of the user. Alternatively, the terminal obtains a setting instruction of the user for the identifier of the terminal location based on the identifier of the start location, and further determines the to-be-traveled road. This is not limited herein.

Based on this, in this embodiment, to-be-traveled time may be further set for the initial navigation information. Specifically, the initial navigation information further includes a to-be-traveled time period, and the driving information of the second vehicle further includes a historical driving time period corresponding to the lane selection information of the second vehicle on the to-be-traveled road. In this case, step 204 that the terminal determines, from the driving information of the second vehicle, target lane selection information that matches the driving preference information specifically includes: The terminal determines, from the driving information of the second vehicle, the target lane selection information that matches the to-be-traveled time period and the driving preference information. The driving information of the second vehicle includes a driving time period corresponding to each piece of lane selection information in the lane selection information of the second vehicle on the to-be-traveled road. For example, the driving information of the second vehicle indicates that driving time periods corresponding to some lane selection information, on the to-be-traveled road, in the lane selection information of the second vehicle on the to-be-traveled road are 8:05 to 9:25, driving time periods corresponding to some lane selection information on the to-be-traveled road are 10:55 to 11:55, and driving time periods corresponding to some other lane selection information on the to-be-traveled road are 22:35 to 23:20 or another time period. Subsequently, the target lane selection information that matches the to-be-traveled time period and the driving preference information may be determined based on the to-be-traveled time period in the initial navigation information. This may better comply with a navigation expectation.

In addition, in an implementation process of the solution, matching between the to-be-traveled time period and the historical driving time period may be performed by using start moments of the two time periods, or may be performed by using end moments of the two time periods, or fuzzy matching may be performed based on the to-be-traveled time period. For example, if the to-be-traveled time period is 7:00 to 8:00, all lane selection information corresponding to a historical driving time period 6:30 to 8:30 may be determined from the driving information of the second vehicle.

In this embodiment of this application, based on any one of the embodiments in FIG. 2 to FIG. 7, it may be learned from the content mentioned above that the driving information of the second vehicle may be the following information in the process in which the second vehicle travels on the to-be-traveled road: the information recorded by the event data recorder, the information recorded by the laser radar, the GPS positioning information, or the other driving information that may be used to determine the lane selection information of the second vehicle on the to-be-traveled road. Therefore, each piece of corresponding lane selection information may be determined from the driving information. In addition, information corresponding to each piece of lane selection information of the second vehicle may be further determined, for example, a lane width, whether an obstacle exists on a lane, an accident on the lane, or a congestion status. Based on this, specifically, in a process of implementing step 204 that the terminal determines, from the driving information of the second vehicle, target lane selection information that matches the driving preference information, the driving preference information may include a driving preference that is preset for the first vehicle on the to-be-traveled road, for example, a duration preference, a driving difficulty preference, and a safety preference on the to-be-traveled road. The following is described by using specific embodiments.

(1) If the driving preference information includes the duration preference, the driving information that is of the second vehicle and that is obtained in step 202 further includes lane driving duration corresponding to the lane selection information of the second vehicle on the to-be-traveled road.

In this case, step 204 that the terminal determines, from the driving information of the second vehicle, target lane selection information that matches the driving preference information specifically includes: The terminal determines, from the driving information of the second vehicle as the target lane selection information, lane selection information corresponding to lane driving duration that matches the duration preference. In other words, when the driving preference information indicates that the first vehicle needs to travel through the to-be-traveled road as fast as possible or slowly pass through the to-be-traveled road (for example, with an intention to appreciate a view along the road), the lane driving duration corresponding to the lane selection information of the second vehicle on the to-be-traveled road may be obtained from the driving information of the second vehicle, namely, driving duration corresponding to each piece of lane selection information in the lane selection information of the second vehicle on the to-be-traveled road, so that the lane selection information that complies with the duration preference is determined from the driving information of the second vehicle.

(2) If the driving preference information includes the difficulty preference, the driving information that is of the second vehicle and that is obtained in step 202 further includes lane road-condition complexity corresponding to the lane selection information of the second vehicle on the to-be-traveled road. The lane road-condition complexity may be specifically obtained based on information such as a lane attribute (for example, a through lane or a through/right-turn lane), a lane width, whether an obstacle exists, an accident on the lane, or a congestion status. A level of the lane road-condition complexity is positively correlated with a magnitude of the difficulty preference, that is, higher lane road-condition complexity indicates a higher difficulty, and lower lane road-condition complexity indicates a lower difficulty.

In this case, step 204 that the terminal determines, from the driving information of the second vehicle, target lane selection information that matches the driving preference information specifically includes: The terminal determines, from the driving information of the second vehicle as the target lane selection information, lane selection information corresponding to a lane road-condition complexity that matches the difficulty preference. In other words, when the driving preference information indicates that a driving difficulty of the first vehicle on the to-be-traveled road needs to be high or low, lane road-condition complexity corresponding to each piece of lane selection information in the lane selection information of the second vehicle on the to-be-traveled road may be obtained from the driving information of the second vehicle, so that the lane selection information that complies with the difficulty preference is determined from the driving information of the second vehicle.

(3) If the driving preference information includes the safety preference, the driving information of the second vehicle in step 202 further includes a quantity of abnormal driving behaviors that corresponds to the lane selection information of the second vehicle on the to-be-traveled road, and the quantity of abnormal driving behaviors specifically includes an accident quantity, a violation quantity, and the like. The quantity of abnormal driving behaviors is negatively correlated with a safety level.

In this case, step 204 that the terminal determines, from the driving information of the second vehicle, target lane selection information that matches the driving preference information specifically includes: The terminal determines, from the driving information of the second vehicle as the target lane selection information, lane selection information corresponding to a quantity of abnormal driving behaviors that matches the safety preference. In other words, when the driving preference information indicates that a safety requirement of the first vehicle on the to-be-traveled road is required, a quantity of abnormal driving behaviors that corresponds to each piece of lane selection information in the lane selection information of the second vehicle on the to-be-traveled road may be obtained from the driving information of the second vehicle, so that the lane selection information that complies with the safety preference is determined from the driving information of the second vehicle.

In this embodiment, the foregoing driving preference information may include the duration preference, the driving difficulty preference, and the safety preference. In addition, another preference parameter may be introduced in an implementation process of the solution. This is not specifically limited herein. For example, refer to Table 1. The following example is used for description: A start point of the to-be-traveled road is an intersection of A and B, an end point thereof is an intersection of A and C, the second vehicle includes four vehicles numbered ID1, ID2, ID3, and ID4, and the driving information of the second vehicle includes a driving intention, use time, a driving difficulty, and a quantity of abnormal behaviors.

TABLE 1

| Number of | | | | | Historical | | Quantity of |
|---|---|---|---|---|---|---|---|
| a second | | Pass-through | Used | Driving | driving | Road-condition | abnormal |
| vehicle | Driving road | time period | lane | intention | duration | complexity | behaviors |
| ID1 | Start point: | Date + time | Lane 1 | Go | 105 min | Intermediate | 2 |
| | intersection | | | straight | | | |
| | of A and B | | | | | | |
| | End point: | | | | | | |
| | intersection | | | | | | |
| | of A and C | | | | | | |
| ID2 | Start point: | Date + time | Lane 2 | Go | 125 min | Low | 1 |
| | intersection | | | straight | | | |
| | of A and B | | | | | | |
| | End point: | | | | | | |
| | intersection | | | | | | |
| | of A and C | | | | | | |
| ID3 | Start point: | Date + time | Lane 2 | Turn | 105 min | High | 0 |
| | intersection | | | right | | | |
| | of A and B | | | | | | |
| | End point: | | | | | | |
| | intersection | | | | | | |
| | of A and C | | | | | | |
| ID4 | Start point: | Date + time | Lane 3 | Turn | 133 min | Low | 3 |
| | intersection | | | right | | | |
| | of A and B | | | | | | |
| | End point: | | | | | | |
| | intersection | | | | | | |
| | of A and C | | | | | | |

In addition, in the process of step 204 that the terminal determines, from the driving information of the second vehicle, target lane selection information that matches the driving preference information, the terminal may further determine the target lane selection information in steps based on a plurality of preference parameters in the driving preference information. For example, the driving preference parameter may be another option, for example, “shortest duration has a higher priority than a high difficulty”, “safety has a higher priority than a lowest difficulty”, “longest duration has a higher priority than safety”, or another combination option. This is not limited herein. Herein, “shortest duration has a higher priority than a high difficulty” is used as an example. In the process of performing step 204, lane selection information corresponding to the shortest duration is first determined from a first lane selection set. When there is more than one piece of lane selection information corresponding to the shortest duration (for example, second vehicles numbered ID1 and ID3 in Table 1), lane selection information corresponding to a highest driving difficulty is determined as the target lane selection information. In other words, in this scenario, lane selection information corresponding to ID3 should be selected as navigation information of the first vehicle on the to-be-traveled road, so that a lane selection of the first vehicle on the to-be-traveled road is consistent with the lane selection information corresponding to ID3, to implement a driving effect (shortest driving duration among driving duration of the second vehicles and highest road-condition complexity) of a vehicle corresponding to ID3 on the to-be-traveled road.

The foregoing describes the vehicle navigation method. With reference to the accompanying drawings, the following describes the terminal provided in the embodiments of this application.

Refer to FIG. 8. An embodiment of this application provides a terminal 800. The terminal 800 may include an obtaining unit 801, a determining unit 802, and a navigation unit 803.

The obtaining unit 801 is configured to obtain an identifier of a to-be-traveled road of a first vehicle.

The obtaining unit 801 is further configured to obtain driving information of a second vehicle based on the identifier of the to-be-traveled road. The second vehicle includes a vehicle traveling on the to-be-traveled road, and the driving information of the second vehicle includes lane selection information of the second vehicle on the to-be-traveled road.

The obtaining unit 801 is further configured to obtain driving preference information of the first vehicle.

The determining unit 802 is configured to determine, from the driving information of the second vehicle, target lane selection information that matches the driving preference information.

The navigation unit 803 is configured to perform vehicle navigation for the first vehicle based on the target lane selection information.

In this embodiment, the obtaining unit 801 is configured to obtain the identifier of the to-be-traveled road of the first vehicle. The obtaining unit 801 is further configured to obtain the driving information of the second vehicle based on the identifier of the to-be-traveled road. The second vehicle includes a vehicle traveling on the to-be-traveled road. The driving information of the second vehicle includes the lane selection information of the second vehicle on the to-be-traveled road. The obtaining unit 801 is further configured to obtain the driving preference information of the first vehicle. The determining unit 802 is configured to determine, from the driving information of the second vehicle, the target lane selection information that matches the driving preference information. The navigation unit 803 is configured to perform vehicle navigation for the first vehicle based on the target lane selection information. Lane-level vehicle navigation is performed for the first vehicle based on the target lane selection information, so that a driving behavior of the first vehicle adapts to a driving behavior of the second vehicle on a same road, and complies with the driving preference information, to improve traveling experience of a passenger in the first vehicle.

In a possible implementation, the obtaining unit 801 is specifically configured to:

send a first data request message to a server, where the first data request message includes the identifier of the to-be-traveled road; and

receive the driving information that is of the second vehicle and that is sent by the server.

In a possible implementation, the obtaining unit 801 is specifically configured to:

send a second data request message to the second vehicle, where the second data request message includes the identifier of the to-be-traveled road; and

receive the driving information that is of the second vehicle and that is sent by the second vehicle.

In a possible implementation, the obtaining unit 801 is specifically configured to:

obtain initial navigation information of the first vehicle, where the initial navigation information includes an identifier of a start location; and

determine the identifier of the to-be-traveled road based on the identifier of the start location.

In a possible implementation, the initial navigation information further includes a to-be-traveled time period, and the driving information of the second vehicle further includes a historical driving time period corresponding to the lane selection information of the second vehicle on the to-be-traveled road. The determining unit 802 is specifically configured to:

determine, from the driving information of the second vehicle, the target lane selection information that matches the to-be-traveled time period and the driving preference information.

In a possible implementation, the driving preference information includes a duration preference, and the driving information of the second vehicle further includes lane driving duration corresponding to the lane selection information of the second vehicle on the to-be-traveled road. The determining unit 802 is specifically configured to:

determine, from the driving information of the second vehicle as the target lane selection information, lane selection information corresponding to lane driving duration that matches the duration preference.

In a possible implementation, the driving preference information includes a difficulty preference, and the driving information of the second vehicle further includes lane road-condition complexity corresponding to the lane selection information of the second vehicle on the to-be-traveled road. A level of the lane road-condition complexity is positively correlated with a magnitude of the difficulty preference. The determining unit 802 is specifically configured to:

determine, by the terminal from the driving information of the second vehicle as the target lane selection information, lane selection information corresponding to lane road-condition complexity that matches the difficulty preference.

In a possible implementation, the driving preference information includes a safety preference, and the driving information of the second vehicle further includes a quantity of abnormal driving behaviors that corresponds to the lane selection information of the second vehicle on the to-be-traveled road. The quantity of abnormal driving behaviors is negatively correlated with a safety level. The determining unit 802 is specifically configured to:

determine, from the driving information of the second vehicle as the target lane selection information, lane selection information corresponding to a quantity of abnormal driving behaviors that matches the safety preference.

In a possible implementation, if the target lane selection information includes lane change information, the navigation unit 803 is specifically configured to:

send a third data request to the server, where the third data request is used to request a lane change decision of the first vehicle in the lane change information;

receive a first lane change instruction sent by the server; and

perform vehicle navigation for the first vehicle based on the first lane change instruction.

In a possible implementation, if the target lane selection information includes lane change information, the navigation unit 803 is specifically configured to:

obtain, based on the lane change information, lane selection information associated with the lane change information;

determine a second lane change instruction based on the lane selection information; and

perform vehicle navigation for the first vehicle based on the second lane change instruction.

In a possible implementation, the navigation unit 803 is specifically configured to:

send a fourth data request message to the server, where the fourth data request message includes a lane change instruction; and

receive the lane selection information that is sent by the server and that is associated with the lane change information.

In a possible implementation, the navigation unit 803 is specifically configured to:

determine, based on the lane change information, a third vehicle associated with the lane change information;

send a fifth data request message to the third vehicle, where the fifth data request message includes the lane change information; and

receive the lane selection information that is sent by the third vehicle and that is associated with the lane change information.

It should be noted that, for details of content such as the processes executed by the units of the foregoing terminal 800, refer to the description in the foregoing method embodiments of this application. Details are not described herein again.

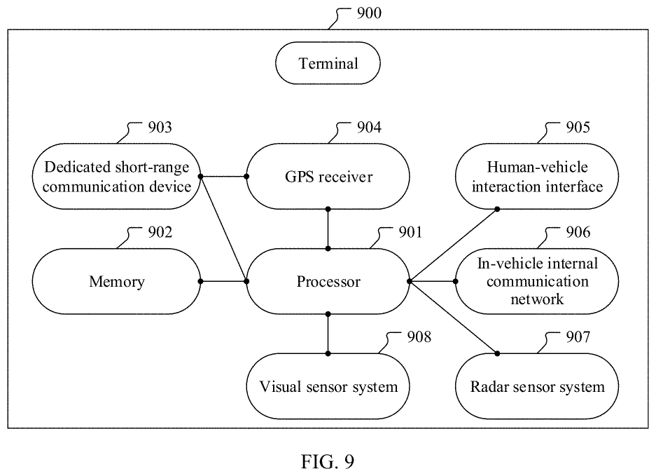

FIG. 9 is a schematic diagram of a possible logical structure of a terminal 900 in the foregoing embodiment according to an embodiment of this application. The terminal 900 may include but is not limited to a processor 901 and a memory 902. In this embodiment of this application, the processor 901 is configured to perform control processing on an action of the terminal 900. For example, based on this, the terminal 900 may be further integrated with another component, such as a dedicated short-range communication device 903, a GPS receiver 904, a human-vehicle interaction interface 905, an in-vehicle internal communication network 906, a radar sensor system 907, a visual sensor system 908, or another component. This is not limited herein.

In addition, the processor 901 may be a central processing unit, a general-purpose processor, a digital signal processor, an application-specific integrated circuit, a field programmable gate array or another programmable logic device, a transistor logic device, a hardware component, or any combination thereof. The processor 901 may implement or execute various example logical blocks, modules, and circuits described with reference to content disclosed in this application. Alternatively, the processor may be a combination of processors implementing a computing function, for example, one or a combination of microprocessors, or a combination of a digital signal processor and a microprocessor. It may be clearly understood by a person skilled in the art that, for the purpose of convenient and brief description, for a detailed working process of the foregoing system, apparatus, and unit, refer to a corresponding process in the foregoing method embodiments, and details are not described herein again.

An embodiment of this application further provides an Internet of vehicles system. The Internet of vehicles system includes the terminal in the foregoing embodiment, and may also include the server in the foregoing embodiment.

An embodiment of this application further provides a computer-readable storage medium that stores one or more computer-executable instructions. When the computer-executable instruction is executed by a processor, the processor performs the method implemented by the foregoing terminal.

An embodiment of this application further provides a computer program product (or referred to as a computer program) that stores one or more computer-executable instructions. When the computer-executable instruction is executed by a processor, the processor performs the method implemented by the foregoing terminal.

An embodiment of this application further provides a chip system. The chip system includes a processor, configured to support a controller in implementing a function of the foregoing terminal. In a possible design, the chip system may further include a memory. The memory is configured to store program instructions and data that are necessary for the controller. The chip system may include a chip, or may include a chip and another discrete component.

In the several embodiments provided in this application, it should be understood that the disclosed system, apparatus, and method may be implemented in other manners. For example, the described apparatus embodiment is merely an example. For example, the unit division is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, functional units in embodiments of this application may be integrated into one processing unit, or each of the units may exist alone physically, or two or more units are integrated into one unit. The integrated unit may be implemented in a form of hardware, or may be implemented in a form of a software function unit.

When the integrated unit is implemented in the form of a software functional unit and sold or used as an independent product, the integrated unit may be stored in a computer-readable storage medium. Based on such an understanding, the technical solutions of this application essentially, or the part contributing to the conventional technology, or all or some of the technical solutions may be implemented in the form of a software product. The computer software product is stored in a storage medium and includes several instructions for instructing a computer device (which may be a personal computer, a server, a network device, or the like) to perform all or some of the steps of the methods in embodiments of this application. The foregoing storage medium includes: any medium that can store program code, such as a USB flash drive, a removable hard disk, a read-only memory (ROM, Read-Only Memory), a random access memory (RAM, Random Access Memory), a magnetic disk, or an optical disc.

What is claimed is:

1. A vehicle navigation method, wherein the method comprises:
obtaining, by a terminal, an identifier of a to-be-traveled road of a first vehicle;
obtaining, by the terminal, driving information of a second vehicle based on the identifier of the to-be-traveled road, wherein the second vehicle comprises a vehicle traveling on the to-be-traveled road, and the driving information of the second vehicle comprises lane selection information of the second vehicle on the to-be-traveled road;
obtaining, by the terminal, driving preference information of the first vehicle;
determining, by the terminal from the driving information of the second vehicle as target lane selection information, lane selection information that matches the driving preference information; and
performing, by the terminal, vehicle navigation for the first vehicle based on the target lane selection information.

2. The method according to claim 1, wherein the obtaining, by the terminal, driving information of a second vehicle based on the identifier of the to-be-traveled road specifically comprises:
sending, by the terminal, a first data request message to a server to obtain the driving information of the second vehicle from the server, wherein the first data request message is used to indicate to request a plurality of pieces of driving information;
receiving, by the terminal, the plurality of pieces of driving information sent by the server, wherein the plurality of pieces of driving information are determined by the server based on the first data request message; and
determining, by the terminal, the driving information of the second vehicle from the plurality of pieces of driving information based on the identifier of the to-be-traveled road.

3. The method according to claim 1, wherein the obtaining, by the terminal, driving information of a second vehicle based on the identifier of the to-be-traveled road specifically comprises:
sending, by the terminal, a second data request message to the second vehicle to obtain the driving information of the second vehicle from the second vehicle, wherein the second data request message is used to indicate to request a plurality of pieces of driving information of the second vehicle;
receiving, by the terminal, the plurality of pieces of driving information of the second vehicle that are sent by the second vehicle, wherein the plurality of pieces of driving information of the second vehicle are determined by the second vehicle based on the second data request message; and
determining, by the terminal, the driving information of the second vehicle from the plurality of pieces of driving information of the second vehicle based on the identifier of the to-be-traveled road.

4. The method according to claim 1, wherein the obtaining, by the terminal, driving information of a second vehicle based on the identifier of the to-be-traveled road specifically comprises:
sending, by the terminal, a third data request message to a server to obtain the driving information of the second vehicle from the server, wherein the third data request message comprises the identifier of the to-be-traveled road; and
receiving, by the terminal, the driving information of the second vehicle that is sent by the server, wherein the driving information of the second vehicle is determined by the server based on the identifier of the to-be-traveled road.

5. The method according to claim 1, wherein the obtaining, by the terminal, driving information of a second vehicle based on the identifier of the to-be-traveled road specifically comprises:
sending, by the terminal, a fourth data request message to the second vehicle to obtain the driving information of the second vehicle from the second vehicle, wherein the fourth data request message comprises the identifier of the to-be-traveled; and
receiving, by the terminal, the driving information of the second vehicle that is sent by the second vehicle, wherein the driving information of the second vehicle is determined by the second vehicle based on the identifier of the to-be-traveled road.

6. The method according to claim 1, wherein the obtaining, by a terminal, an identifier of a to-be-traveled road of a first vehicle specifically comprises:
obtaining, by the terminal, initial navigation information of the first vehicle, wherein the initial navigation information comprises an identifier of a start location; and
determining, by the terminal, the identifier of the to-be-traveled road based on the identifier of the start location.

7. The method according to claim 6, wherein the initial navigation information further comprises a to-be-traveled time period, the driving information of the second vehicle further comprises a historical driving time period corresponding to the lane selection information of the second vehicle on the to-be-traveled road, and the determining, by the terminal from the driving information of the second vehicle as target lane selection information, lane selection information that matches the driving preference information specifically comprises:
determining, by the terminal from the driving information of the second vehicle, the target lane selection information that matches the to-be-traveled time period and the driving preference information.

8. The method according to claim 1, wherein the driving preference information comprises a duration preference, and the driving information of the second vehicle further comprises lane driving duration corresponding to the lane selection information of the second vehicle on the to-be-traveled road; and
the determining, by the terminal from the driving information of the second vehicle as target lane selection information, lane selection information that matches the driving preference information specifically comprises:
determining, by the terminal from the driving information of the second vehicle as the target lane selection information, lane selection information corresponding to lane driving duration that matches the duration preference.

9. The method according to claim 1, wherein the driving preference information comprises a difficulty preference, the driving information of the second vehicle further comprises lane road-condition complexity corresponding to the lane selection information of the second vehicle on the to-be-traveled road, and a level of the lane road-condition complexity is positively correlated with a magnitude of the difficulty preference; and
the determining, by the terminal from the driving information of the second vehicle as target lane selection information, lane selection information that matches the driving preference information specifically comprises:
determining, by the terminal from the driving information of the second vehicle as the target lane selection information, lane selection information corresponding to lane road-condition complexity that matches the difficulty preference.

10. The method according to claim 1, wherein the driving preference information comprises a safety preference, the driving information of the second vehicle further comprises a quantity of abnormal driving behaviors that corresponds to the lane selection information of the second vehicle on the to-be-traveled road, and the quantity of abnormal driving behaviors is negatively correlated with a safety level; and
the determining, by the terminal from the driving information of the second vehicle as target lane selection information, lane selection information that matches the driving preference information specifically comprises:
determining, by the terminal from the driving information of the second vehicle as the target lane selection information, lane selection information corresponding to a quantity of abnormal behaviors that matches the safety preference.

11. The method according to claim 1, wherein if the target lane selection information comprises lane change information, the performing, by the terminal, vehicle navigation for the first vehicle based on the target lane selection information specifically comprises:
sending, by the terminal, a fifth data request message to a server, wherein the fifth data request message is used to indicate to request a lane change decision of the first vehicle in the lane change information;
receiving, by the terminal, a first lane change instruction sent by the server, wherein the first lane change instruction is determined by the server based on the fifth data request message; and
performing, by the terminal, vehicle navigation for the first vehicle based on the first lane change instruction.

12. The method according to claim 1, wherein if the target lane selection information comprises lane change information, the performing, by the terminal, vehicle navigation for the first vehicle based on the target lane selection information specifically comprises:
obtaining, by the terminal based on the lane change information, lane selection information associated with the lane change information;
determining, by the terminal, a second lane change instruction based on the lane selection information associated with the lane change information; and
performing, by the terminal, vehicle navigation for the first vehicle based on the second lane change instruction.

13. The method according to claim 12, wherein the obtaining, by the terminal based on the lane change information, lane selection information associated with the lane change information specifically comprises:
sending, by the terminal, a sixth data request message to the server, wherein the sixth data request message comprises the lane change information; and
receiving, by the terminal, the lane selection information that is associated with the lane change information and that is sent by the server, wherein the lane selection information associated with the lane change information is determined by the server based on the lane change information.

14. The method according to claim 12, wherein the obtaining, by the terminal based on the lane change information, lane selection information associated with the lane change information specifically comprises:
determining, by the terminal based on the lane change information, a third vehicle associated with the lane change information;
sending, by the terminal, a fifth data request message to the third vehicle, wherein the fifth data request message comprises the lane change information; and
receiving, by the terminal, the lane selection information that is associated with the lane change information and that is sent by the third vehicle, wherein the lane selection information associated with the lane change information is determined by the third vehicle based on the lane change information.

15. A terminal, wherein the terminal comprises an obtaining unit, a determining unit, and a navigation unit, wherein
the obtaining unit is configured to obtain an identifier of a to-be-traveled road of a first vehicle;
the obtaining unit is further configured to obtain driving information of a second vehicle based on the identifier of the to-be-traveled road, wherein the second vehicle comprises a vehicle traveling on the to-be-traveled road, and the driving information of the second vehicle comprises lane selection information of the second vehicle on the to-be-traveled road;
the obtaining unit is further configured to obtain driving preference information of the first vehicle;
the determining unit is configured to determine, from the driving information of the second vehicle as target lane selection information, lane selection information that matches the driving preference information; and
the navigation unit is configured to perform vehicle navigation for the first vehicle based on the target lane selection information.

16. The terminal according to claim 15, wherein the obtaining unit is specifically configured to:
send a first data request message to a server to obtain the driving information of the second vehicle from the server, wherein the first data request message is used to indicate to request a plurality of pieces of driving information;
receive the plurality of pieces of driving information sent by the server, wherein the plurality of pieces of driving information are determined by the server based on the first data request message; and
determine the driving information of the second vehicle from the plurality of pieces of driving information based on the identifier of the to-be-traveled road.

17. The terminal according to claim 15, wherein the obtaining unit is specifically configured to:
send a second data request message to the second vehicle to obtain the driving information of the second vehicle from the second vehicle, wherein the second data request message is used to indicate to request a plurality of pieces of driving information of the second vehicle;
receive the plurality of pieces of driving information of the second vehicle that are sent by the second vehicle, wherein the plurality of pieces of driving information of the second vehicle are determined by the second vehicle based on the second data request message; and
determine the driving information of the second vehicle from the plurality of pieces of driving information of the second vehicle based on the identifier of the to-be-traveled road.

18. The terminal according to claim 15, wherein the obtaining unit is specifically configured to:
send a third data request message to a server to obtain the driving information of the second vehicle from the server, wherein the third data request message comprises the identifier of the to-be-traveled road; and
receive the driving information of the second vehicle that is sent by the server, wherein the driving information of the second vehicle is determined by the server based on the identifier of the to-be-traveled road.

19. The terminal according to claim 15, wherein the obtaining unit is specifically configured to:
send a fourth data request message to the second vehicle to obtain the driving information of the second vehicle from the second vehicle, wherein the fourth data request message comprises the identifier of the to-be-traveled; and
receive the driving information of the second vehicle that is sent by the second vehicle, wherein the driving information of the second vehicle is determined by the second vehicle based on the identifier of the to-be-traveled road.

20. The terminal according to claim 15, wherein the obtaining unit is specifically configured to:
obtain initial navigation information of the first vehicle, wherein the initial navigation information comprises an identifier of a start location; and
determine the identifier of the to-be-traveled road based on the identifier of the start location.

21. The terminal according to claim 20, wherein the initial navigation information further comprises a to-be-traveled time period, the driving information of the second vehicle further comprises a historical driving time period corresponding to the lane selection information of the second vehicle on the to-be-traveled road, and the determining unit is specifically configured to:
determine, from the driving information of the second vehicle, the target lane selection information that matches the to-be-traveled time period and the driving preference information.

22. The terminal according to claim 15, wherein the driving preference information comprises a duration preference, the driving information of the second vehicle further comprises lane driving duration corresponding to the lane selection information of the second vehicle on the to-be-traveled road, and the determining unit is specifically configured to:
determine, from the driving information of the second vehicle as the target lane selection information, lane selection information corresponding to lane driving duration that matches the duration preference.

23. The terminal according to claim 15, wherein the driving preference information comprises a difficulty preference, the driving information of the second vehicle further comprises lane road-condition complexity corresponding to the lane selection information of the second vehicle on the to-be-traveled road, a level of the lane road-condition complexity is positively correlated with a magnitude of the difficulty preference, and the determining unit is specifically configured to:
determine, from the driving information of the second vehicle as the target lane selection information, lane selection information corresponding to lane road-condition complexity that matches the difficulty preference.

24. The terminal according to claim 15, wherein the driving preference information comprises a safety preference, the driving information of the second vehicle further comprises a quantity of abnormal driving behaviors that corresponds to the lane selection information of the second vehicle on the to-be-traveled road, the quantity of abnormal driving behaviors is negatively correlated with a safety level, and the determining unit is specifically configured to:
determine, from the driving information of the second vehicle as the target lane selection information, lane selection information corresponding to a quantity of abnormal behaviors that matches the safety preference.

25. The terminal according to claim 15, wherein if the target lane selection information comprises lane change information, the navigation unit is specifically configured to:
send a fifth data request message to a server, wherein the fifth data request message is used to indicate to request a lane change decision of the first vehicle in the lane change information;
receive a first lane change instruction sent by the server, wherein the first lane change instruction is determined by the server based on the fifth data request message; and
perform vehicle navigation for the first vehicle based on the first lane change instruction.

26. The terminal according to claim 15, wherein if the target lane selection information comprises lane change information, the navigation unit is specifically configured to:
obtain, based on the lane change information, lane selection information associated with the lane change information;
determine a second lane change instruction based on the lane selection information associated with the lane change information; and
perform vehicle navigation for the first vehicle based on the second lane change instruction.

27. The terminal according to claim 26, wherein the navigation unit is specifically configured to:
send a sixth data request message to the server, wherein the sixth data request message comprises the lane change information; and
receive the lane selection information that is associated with the lane change information and that is sent by the server, wherein the lane selection information associated with the lane change information is determined by the server based on the lane change information.

28. The terminal according to claim 26, wherein the navigation unit is specifically configured to:
determine, based on the lane change information, a third vehicle associated with the lane change information;
send a fifth data request message to the third vehicle, wherein the fifth data request message comprises the lane change information; and
receive the lane selection information that is associated with the lane change information and that is sent by the third vehicle, wherein the lane selection information associated with the lane change information is determined by the third vehicle based on the lane change information.

29. A terminal, comprising:
a processor and a memory, wherein
the memory is configured to store program instructions; and
the processor is configured to execute the program instructions, to enable the terminal to implement the method according to claim 1.

30. A computer program product comprising instructions, wherein when the computer program product runs on a computer, the computer is enabled to perform the method according to claim 1.

31. A computer-readable storage medium, wherein the computer-readable storage medium is configured to store program instructions, and when the program instructions are run on a computer, the computer is enabled to perform the method according to claim 1.
